(19) United States
(12) Patent Application Publication
(10) Pub. No.: US 2023/0350063 A1
(43) Pub. Date: Nov. 2, 2023

(54) DISTANCE MEASURING DEVICE AND CALIBRATION METHOD

(71) Applicant: Sony Semiconductor Solutions Corporation, Kanagawa (JP)

(72) Inventor: Mitsuharu Ohki, Tokyo (JP)

(21) Appl. No.: 18/044,738

(22) PCT Filed: Jul. 19, 2021
(86) PCT No.: PCT/JP2021/027016

§ 371 Date: Mar. 9, 2023

(30) Foreign Application Priority Data
Sep. 16, 2020 (JP) 2020-155534

(51) Int. Cl. G01S 17/36; G01S 7/497

(52) U.S. Cl. CPC G01S 17/36; G01S 7/497

(57) ABSTRACT

A distance measuring device according to a technology includes a light emitting unit that emits light, a light receiving sensor that receives the light emitted from the light emitting unit and reflected by a target object, and a calibration calculation unit that performs, as calibration calculation processing for obtaining a correction parameter for distance information calculated by an indirect ToF method on the basis of a light reception signal of the light receiving sensor, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

### TECHNICAL FIELD

The present technology relates to a distance measuring device and a calibration method thereof, and particularly relates to a technology for obtaining a correction parameter for distance information calculated by an indirect ToF method.

### BACKGROUND ART

Various distance measurement techniques for measuring a distance to a target object are known, and in recent years, for example, a distance measurement technique based on a time of flight (ToF) method has attracted attention.

As the ToF method, a direct ToF method and an indirect ToF method are known.

Among these ToF methods, in the indirect ToF method, distance measurement is performed by emitting sine wave light and receiving light that has hit and been reflected by a target object.

At this time, a sensor that receives light has pixels arranged in a two-dimensional array. Each pixel has a light receiving element and can capture light. Then, each pixel can obtain the phase and amplitude of the received sine wave by receiving light in synchronization with the phase of the light being emitted. Note that the reference of the phase is based on the emitted sine wave.

The phase of each pixel corresponds to the time until light from a light emitting unit is input to the sensor through reflection by the target object.

Therefore, by dividing the phase by 2πf, further multiplying by the light speed (hereinafter referred to as “c”), and dividing by 2, the distance of a distance measurement target point (distance measurement point) projected on the pixel can be calculated. Note that f represents the frequency of the sine wave that emits light.

Here, in the indirect ToF, the light actually emitted is not strictly a sine wave (for example, a square wave). Thus, the above-described distance calculated by the above calculation is not strictly a correct distance. An element that causes an error in the distance due to the fact that the light emitted in this manner is not a sine wave is known as a “circular error”.

If the circular error can be obtained, the correct distance can be obtained by correcting the distance using the circular error.

Non Patent Document 1 below discloses a technique for correcting a distance using a correction parameter as this circular error.

### CITATION LIST

### Patent Document

Non Patent Document 1: Fuchs, S., May, S.: Calibration and registration for precise surface reconstruction with time-of-flight cameras. Int. J. Intell. Syst. Technol. Appl. 5, 274-284(2008)

### SUMMARY OF THE INVENTION

### Problems to be Solved by the Invention

Here, conventionally, calibration for obtaining the correction parameter as the circular error is performed on the condition that the distance to the target object is a known distance, and it is necessary to strictly arrange the target object at the known distance. For this reason, the conventional calibration is performed using a precise device before product shipment, and it has been quite difficult to perform calibration in an actual use environment after product shipment.

The present technology has been made in view of the above-described circumstances, and an object thereof is to enable calibration for obtaining a correction parameter for distance information calculated by the indirect ToF method to be executed under an actual use environment of a device.

### Solutions to Problems

A first distance measuring device according to the present technology includes a light emitting unit that emits light, a light receiving sensor that receives the light emitted from the light emitting unit and reflected by a target object, and a calibration calculation unit that performs, as calibration calculation processing for obtaining a correction parameter for distance information calculated by an indirect ToF method on the basis of a light reception signal of the light receiving sensor, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

By using a plurality of light emission frequencies, the correction parameter can be obtained even if the distance to the target object is indefinite.

In the above-described first distance measuring device according to the present technology, a configuration is conceivable in which the calibration calculation unit performs calculation processing based on a phase difference between light emission and light reception detected on the basis of the light reception signal, and obtains the correction parameter.

Thus, it is possible to obtain an appropriate correction parameter corresponding to a case of performing distance measurement by the indirect ToF method as a phase difference method.

In the first distance measuring device according to the present technology described above, a configuration is conceivable in which the calibration calculation unit performs indefiniteness elimination processing of eliminating indefiniteness in units of 2π for the phase difference.

Thus, calculation processing of the correction parameter can be performed using the phase difference from which the indefiniteness in units of 2π has been eliminated.

In the above-described first distance measuring device according to the present technology, a configuration is conceivable in which the calibration calculation unit determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

With respect to the phase difference corresponding to the lowest light emission frequency, the indefiniteness in units of 2π can be eliminated by selecting the phase difference detected from the light reception signal having the amplitude equal to or more than the predetermined value as described above, and with respect to the phase difference corresponding to another one of the light emission frequencies other than the lowest light emission frequency, a true phase difference can be specified on the basis of the phase difference corresponding to the lowest light emission frequency from which the indefiniteness is eliminated in this manner (that is, the indefiniteness in units of 2π can be eliminated).

In the above-described first distance measuring device according to the present technology, a configuration is conceivable in which the calibration calculation unit executes the calibration calculation processing on the basis of an elapsed time from previous execution.

Thus, even in a case where the correction parameter deviates from the true value over time, it is possible to recalibrate the correction parameter.

In the first distance measuring device according to the present technology described above, a configuration is conceivable in which in a case where a distance measurement instruction is given during execution of the calibration calculation processing, the calibration calculation unit interrupts the calibration calculation processing and performs processing for distance measurement.

Thus, even in a case where the calibration calculation processing is performed in the background, the calibration calculation processing is interrupted in a case where a distance measurement instruction is given, and a distance measurement operation is performed according to the instruction.

A first calibration method according to the present technology is a calibration method in a distance measuring device that includes a light emitting unit that emits light, and a light receiving sensor that receives the light emitted from the light emitting unit and reflected by a target object, and performs distance measurement by an indirect ToF method on the basis of a light reception signal of the light receiving sensor, the calibration method including performing, as calibration calculation processing for obtaining a correction parameter for distance information calculated by the indirect ToF method, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

Also by such a first calibration method, it is possible to obtain a similar operation to that of the first distance measuring device according to the present technology described above.

A second distance measuring device according to the present technology includes a light emitting unit that emits light, a light receiving sensor that receives the light emitted from the light emitting unit and reflected by a target object by a plurality of pixels, and a calibration calculation unit that performs, as calibration calculation processing for obtaining a correction parameter for distance information calculated by an indirect ToF method on the basis of a light reception signal of the light receiving sensor, calculation processing using a condition that respective distance measurement points projected onto a plurality of the pixels are in a specific positional relationship with each other.

By using the condition that the distance measurement points are in a specific positional relationship with each other as described above, the correction parameter can be obtained even if the distance to the target object is indefinite.

In the second distance measuring device according to the present technology described above, a configuration is conceivable in which the calibration calculation unit performs calculation processing using a condition that the distance measurement points are on an object having a known shape as the calibration calculation processing.

If the distance measurement points are on an object having a known shape, the positional relationship between the distance measurement points can be defined as a mathematical expression by the known shape.

In the second distance measuring device according to the present technology described above, a configuration is conceivable in which the calibration calculation unit performs, as the calibration calculation processing, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

That is, as the calibration calculation processing, calculation processing using a plurality of light emission frequencies is performed while using the condition that respective distance measurement points are in a specific positional relationship with each other, and thus it is possible to increase the number of equations for an unknown number.

In the second distance measuring device according to the present technology described above, a configuration is conceivable in which the calibration calculation unit performs calculation processing based on a phase difference between light emission and light reception detected on the basis of the light reception signal, and obtains the correction parameter.

Thus, it is possible to obtain an appropriate correction parameter corresponding to a case of performing distance measurement by the indirect ToF method as the phase difference method.

In the second distance measuring device according to the present technology described above, a configuration is conceivable in which the calibration calculation unit performs indefiniteness elimination processing of eliminating indefiniteness in units of 2π for the phase difference.

Thus, the calculation processing of the correction parameter can be performed using the phase difference from which the indefiniteness in units of 2π has been eliminated.

In the second distance measuring device according to the present technology described above, a configuration is conceivable in which the calibration calculation unit determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

With respect to the phase difference corresponding to the lowest light emission frequency, the indefiniteness in units of 2π can be eliminated by selecting the phase difference detected from the light reception signal having the amplitude equal to or more than the predetermined value as described above, and with respect to the phase difference corresponding to another one of the light emission frequencies other than the lowest light emission frequency, a true phase difference can be specified on the basis of the phase difference corresponding to the lowest light emission frequency from which the indefiniteness is eliminated in this manner (that is, the indefiniteness in units of 2π can be eliminated).

In the second distance measuring device according to the present technology described above, a configuration is conceivable in which a guide display processing unit that performs display processing of a guide image that guides a composition for satisfying a condition that the distance measurement points are in a specific positional relationship with each other is further included.

Thus, it is possible to increase the possibility that the correction parameter is calibrated under the condition that the distance measurement points are in a specific positional relationship with each other.

A second calibration method according to the present technology is a calibration method in a distance measuring device that performs, with a light emitting unit that emits light and a light receiving sensor that receives the light emitted from the light emitting unit and reflected by a target object by a plurality of pixels, distance measurement by an indirect ToF method on the basis of a light reception signal of the light receiving sensor, the calibration method including performing calculation processing using a condition that respective distance measurement points projected onto a plurality of the pixels are in a specific positional relationship with each other as calibration calculation processing for obtaining a correction parameter for distance information calculated by the indirect ToF method.

Also by such a second calibration method, it is possible to obtain a similar operation to that of the second distance measuring device according to the present technology described above.

### BRIEF DESCRIPTION OF DRAWINGS

FIG. 1 is a block diagram for describing an internal configuration example of a distance measuring device as a first embodiment according to the present technology.

FIG. 2 is an explanatory diagram of 2π indefiniteness.

FIG. 3 is a flowchart of calibration calculation processing as the first embodiment.

FIG. 4 is a flowchart of 2π indefiniteness elimination processing.

FIG. 5 is a flowchart of processing executed by a control unit in a second embodiment.

FIG. 6 is a flowchart of calibration calculation processing in the second embodiment.

FIG. 7 is a block diagram for describing an internal configuration example of a distance measuring device as a third embodiment.

FIG. 8 is a diagram schematically illustrating a state of the distance measuring device when performing calibration according to the third embodiment.

FIG. 9 is an explanatory diagram of a planar imaging area.

FIG. 10 is a diagram for describing an example of guide display at a time of calibration in the third embodiment.

FIG. 11 is a flowchart illustrating a flow of processing when performing calibration as the third embodiment.

FIG. 12 is a flowchart of calibration processing in the third embodiment.

### MODE FOR CARRYING OUT THE INVENTION

Hereinafter, an embodiment according to the present technology will be described in the following order with reference to the accompanying drawings.
<1. First Embodiment>
[1-1. Configuration of distance measuring device]
[1-2. 2π Indefiniteness]
[1-3. Calibration method as first embodiment]
<2. Second Embodiment>
<3. Third Embodiment>
<4. Modification examples>
<5. Summary of embodiment>
<6. Present technology>

### 1. First Embodiment

### 1-1. Configuration of Distance Measuring Device

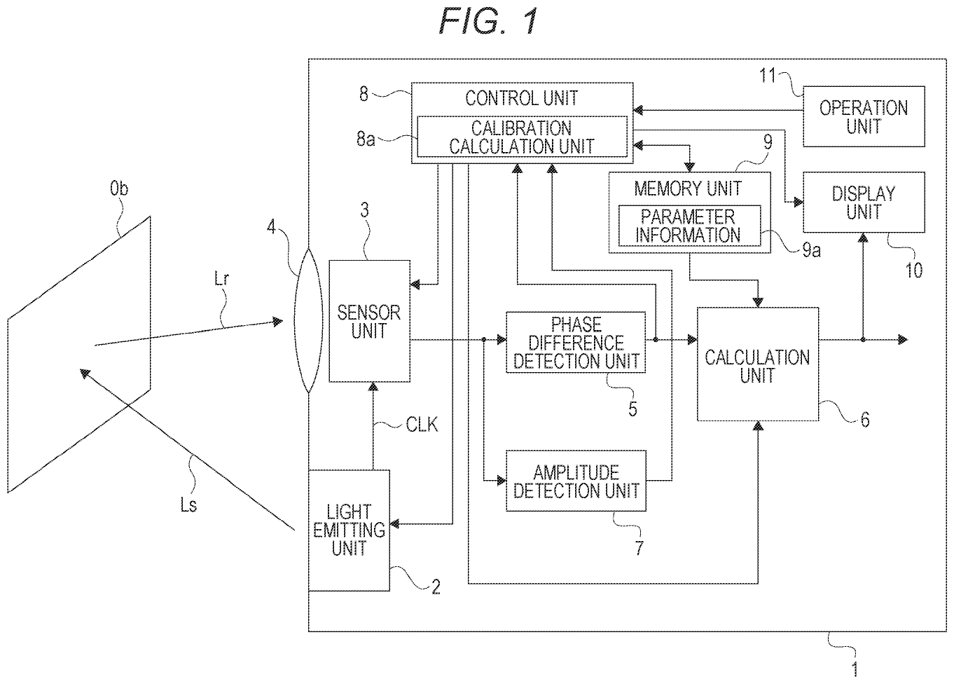

FIG. 1 is a block diagram for describing an internal configuration example of a distance measuring device 1 as a first embodiment according to the present technology.

The distance measuring device 1 performs distance measurement by an indirect time of flight (ToF) method. The indirect ToF method is a distance measuring method of calculating a distance to a target object Ob on the basis of a phase difference between irradiation light Ls with respect to the target object Ob and reflected light Lr obtained by reflecting the irradiation light Ls by the target object Ob.

In the present example, the distance measuring device 1 is configured as a portable information processing device such as a smartphone or a tablet terminal having a distance measuring function by the indirect ToF method.

As illustrated, the distance measuring device 1 includes a light emitting unit 2, a sensor unit 3, a lens 4, a phase difference detection unit 5, a calculation unit 6, an amplitude detection unit 7, a control unit 8, a memory unit 9, a display unit 10, and an operation unit 11.

The light emitting unit 2 includes one or more light emitting elements as a light source, and emits the irradiation light Ls to the target object Ob. In the present example, the light emitting unit 2 emits, for example, infrared light having a wavelength in the range of 780 nm to 1000 nm as the irradiation light Ls.

In the indirect ToF method, light whose intensity is modulated so that the intensity changes at a predetermined cycle is used as the irradiation light Ls. Specifically, in the present example, the irradiation light Ls is repeatedly emitted according to a clock CLK. In this case, the irradiation light Ls is not strictly a sine wave, but is a substantially sine wave.

In the present example, the frequency of the clock CLK is variable, and thus the light emission frequency of the irradiation light Ls is also variable. The light emission frequency of the irradiation light Ls can be changed within a predetermined frequency range with, for example, 10 MHz (megahertz) as a basic frequency.

The sensor unit 3 has a plurality of pixels arranged in a two-dimensional array. Each pixel includes, for example, a light receiving element such as a photodiode, and the light receiving element receives the reflected light Lr. A lens 4 is attached to a front surface of the sensor unit 3, and the reflected light Lr is condensed by the lens 4 and is efficiently received by each pixel in the sensor unit 3.

The clock CLK is supplied to the sensor unit 3 as a timing signal of light receiving operation, and thereby the sensor unit 3 performs the light receiving operation in synchronization with the cycle of the irradiation light Ls emitted from the light emitting unit 2.

The sensor unit 3 accumulates the reflected light Lr for several tens of thousands of cycles with respect to the cycle of the irradiation light Ls, and outputs data proportional to the accumulated amount of received light. Note that the reason for the accumulation is that although one light reception is a small amount, the amount of received light can be gained by accumulating several tens of thousands of times, and significant data can be acquired. Therefore, the distance measurement is performed at intervals of several tens of thousands of cycles in the light emission cycle of the irradiation light Ls.

The phase difference detection unit 5 detects a phase difference corresponding to a time difference from a light emission timing of the irradiation light Ls to a light reception timing of the reflected light Lr using data proportional to the accumulated amount of received light output from each pixel of the sensor unit 3. This phase difference is proportional to the distance to the target object Ob.

Note that, although not illustrated, in the indirect ToF method, two floating diffusions (FDs) are provided for one light receiving element in each pixel of the sensor unit 3, and accumulated charges of the light receiving element are distributed to these FDs within one light emission cycle of the irradiation light Ls. Then, data proportional to the charges accumulated in these FDs over a period of several tens of thousands of light emission cycles of the irradiation light Ls is output from each pixel. The phase difference detection unit 5 detects the phase difference on the basis of the data of each FD output from each pixel in this manner.

The calculation unit 6 calculates the distance for each pixel on the basis of the phase difference detected for each pixel by the phase difference detection unit 5. Specifically, the distance for each pixel is calculated by multiplying the phase difference detected by the phase difference detection unit 5 by {c±(4πf)}. Note that f is a light emission frequency (frequency of sine wave) of the irradiation light Ls.

Hereinafter, the information indicating the distance for each pixel obtained by the calculation unit 6 is referred to as a “distance image”.

The amplitude detection unit 7 detects the amplitude of the received reflected light Lr (sine wave) using data proportional to the accumulated amount of received light output from each pixel of the sensor unit 3.

The control unit 8 includes a microcomputer including, for example, a central processing unit (CPU), a read only memory (ROM), a random access memory (RAM), and the like, and performs overall control of the distance measuring device 1 by executing processing according to a program stored in the ROM described above, for example.

For example, the control unit 8 performs operation control of the light emitting unit 2 including control of the light emission frequency of the irradiation light Ls, control of light receiving operation by the sensor unit 3, and execution control of distance calculation processing by the calculation unit 6.

Furthermore, the control unit 8 performs control of display operation by the display unit 10 and various types of processing according to operation input information from the operation unit 11.

The display unit 10 is a display device capable of displaying an image, such as a liquid crystal display or an organic electro-luminescence (EL) display, for example, and displays various types of information in accordance with an instruction from the control unit 8.

The operation unit 11 comprehensively represents, for example, operation elements such as various buttons, keys, and a touch panel provided in the distance measuring device 1. The operation unit 11 outputs operation input information according to an operation input from the user to the control unit 8. The control unit 8 achieves the operation of the distance measuring device 1 according to the operation input from the user by executing processing according to the operation input information.

The memory unit 9 includes, for example, a nonvolatile memory, and is used for storing various data handled by the control unit 8 and the calculation unit 6. In the present embodiment, information of a correction parameter used for correction of a distance to be described later is stored in the memory unit 9 as parameter information 9a, and this point will be described again.

The control unit 8 has a function as a calibration calculation unit 8a. The correction parameter used for distance correction is obtained by the function as the calibration calculation unit 8a, and this point will be described again later.

### [1-2. 2π Indefiniteness]

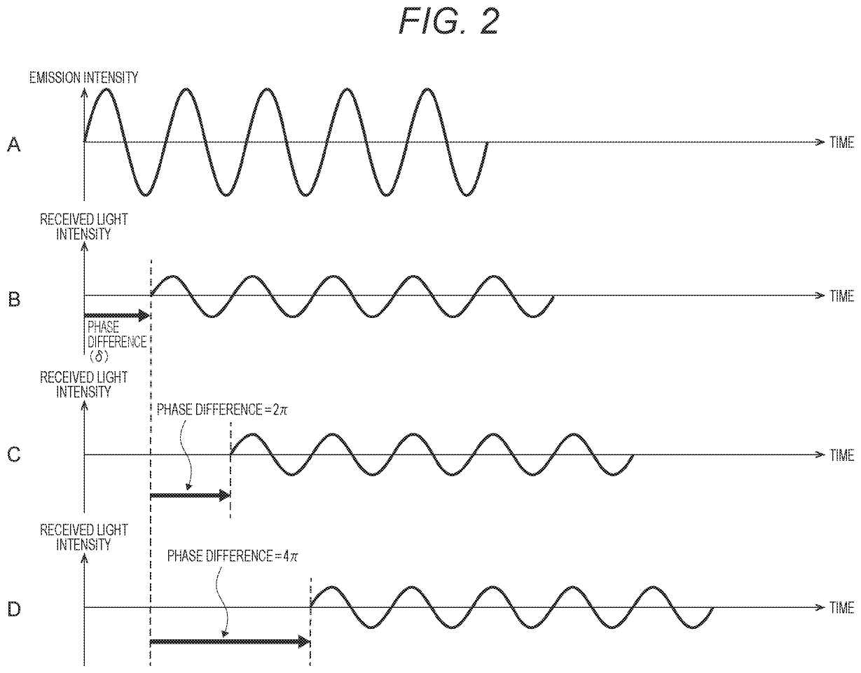

The indefiniteness in units of 2π of the phase difference (hereinafter referred to as “2π indefiniteness”) will be described with reference to FIG. 2.

FIG. 2A illustrates a temporal change in emission intensity of the irradiation light Ls (sine wave) emitted from the light emitting unit 2. FIG. 2B illustrates a temporal change in received light intensity of the reflected light Lr from the target object Ob. The phase difference (denoted by δ) between FIGS. 2A and 2B is proportional to the distance between the distance measuring device 1 and the target object Ob.

Here, when the position of the target object Ob is further distant, the phase difference may be further shifted by 2π (see FIG. 2C) or may be shifted by 4π (see FIG. 2D). Moreover, a deviation of 6π or more is also conceivable.

Since the phase difference detection unit 5 detects only the phase difference, the cases of FIGS. 2B, 2C, and 2D cannot be distinguished. That is, which of δ+2sπ (where s is an integer of 0 or more) the phase difference cannot be determined. Describing for the distance, which of {((δ+2sπ)×c÷(4πf)} (where s is an integer of 0 or more) it cannot be determined. In this manner, the fact that which of δ+2sπ it cannot be determined for the phase difference is herein referred to as 2π indefiniteness.

Note that, in the indirect ToF method, a value of s=0 is generally output. That is, δ×c÷(4πf) is output as the distance. Here, δ is a value of 0 or more and less than 2π.

### 1-3. Calibration Method as First Embodiment

Here, as described above, since the irradiation light Ls is not a perfect sine wave in practice, correction is required in the calculation of the distance in the calculation unit 6. The parameter for calculating the correction is stored as the parameter information 9a in the memory unit 9. Therefore, the calculation unit 6 not only simply “multiplies the phase difference by {c÷(4πf)}” but also performs complicated calculation. This “complicated calculation” will be described below.

As the parameter information 9a, values A1 to An and B1 to Bn, ag, bg, and cg are stored. These are parameters for performing correction calculation. Note that N is a predetermined value, for example, N=20.

As described in Chapter 4 of Non Patent Document 1, it is necessary to correct a circular error and a signal propagation delay.

Since the circular error has periodicity, it can be expressed by a trigonometric function. Accordingly, a component of the circular error at a frequency n times the phase observed in the sensor unit 3 is An, and a phase shift at the frequency is denoted by Bn. Here, n may take a value from 1 to N.

The signal propagation delay is mainly in consideration of signal propagation delay for each pixel in the sensor unit 3. The signal propagation delay for each pixel is caused by a difference in time until charge resetting is performed depending on the pixel position.

The signal propagation delay has linearity for the pixel position as described in Chapter 4 of Non Patent Document 1. Accordingly, the phase shift of the entire pixel is denoted by ag, an inclination of a delay amount with respect to the position of the pixel position in a row direction (horizontal direction) is denoted by bg, and an inclination of a delay amount with respect to the position in a column direction (vertical direction) is denoted by cg. Note that, in Chapter 4 of Non Patent Document 1, ag is described as b0, bg is described as b1, and cg is described as b2.

Here, the number of pixels of the sensor unit 3 is denoted by U×V, and the pixel position of the sensor unit 3 is denoted by (u, v). In this case, u=1 to U and v=1 to V.

Furthermore, a phase difference (that is, the phase difference calculated by the phase difference detection unit 5) observed at the pixel position (u, v) is denoted by θ(u, v).

The distance L(u, v) corresponding to the pixel position (u, v) is calculated by the following [Expression 1] including An, Bn, ag, bg, and cg as the correction parameters described above.

$$\begin{matrix}[ Expression 1 ] & \\ {L}_{( u , v )} = \frac{c}{4 π f} \{ {ϕ}_{( u , v )} + {\sum }_{n = 1}^{N} {A}_{n} sin ( n {ϕ}_{( u , v )} + {B}_{n} ) \} & [ Expression 1 ]\end{matrix}$$

$$where {ϕ}_{( u , v )} = {θ}_{( u , v )} + {a}_{g} + {b}_{g} u + {c}_{g} v$$

That is, the calculation unit 6 performs the calculation described in [Expression 1] using the parameters A1 to An, B1 to Bn, and ag, bg, and cg instead of simply “multiplying the phase difference θ by {c÷(4πf)}”. L(u, v) which is a calculation result thereof is obtained as a distance measurement result with respect to the pixel position (u, v).

Note that the parameters A1 to An and B1 to Bn, ag, bg, and cg are obtained by performing measurement using a precise device at the time of product shipment. The obtained values are stored in advance in the memory unit 9 as the parameter information 9a.

Here, due to a secular change, there is a possibility that the values of the parameters A1 to An and B1 to Bn deviate from the true values and become inappropriate values. Accordingly, even if the user is using the distance measuring device 1, calibration may be performed to update the parameters A1 to An and B1 to Bn stored as the parameter information 9a. For this purpose, it is desirable that the calibration can be easily performed without using the precise device (the values of the parameters A1 to An and B1 to Bn can be calculated).

Note that, as a matter of course, at the time of product shipment, the calibration may be performed using a method as an embodiment, and parameters A1 to An and B1 to Bn as results of the calibration may be stored and shipped as the parameter information 9a. An advantage of employing the method as the embodiment in this case is that the calibration can be performed without installing the precise device in the factory.

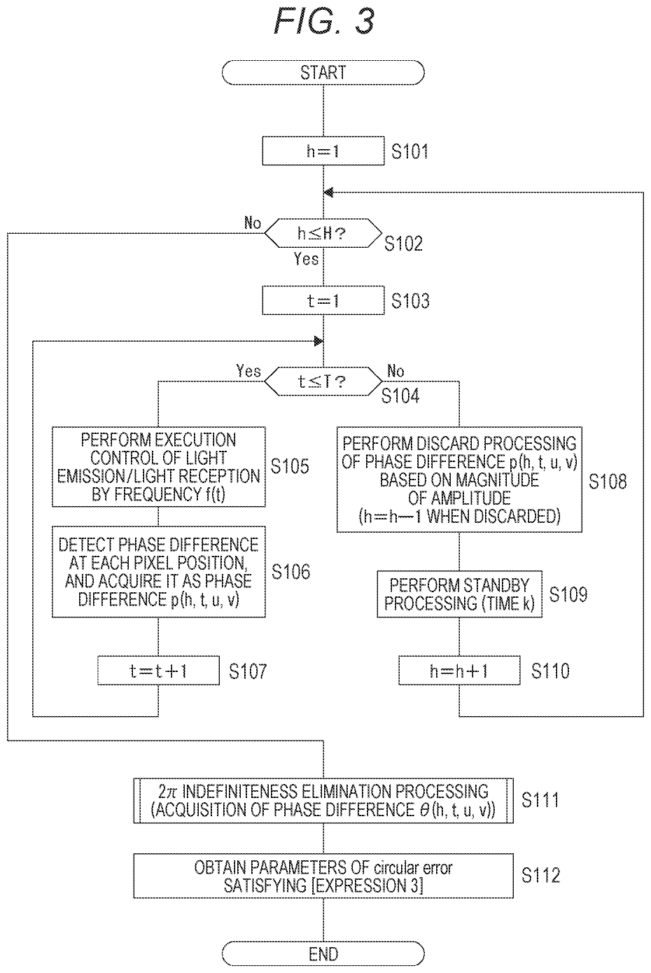

Calibration calculation processing as the first embodiment will be described with reference to a flowchart of FIG. 3. This processing is processing of the calibration calculation unit 8a illustrated in FIG. 1, and is executed by the control unit 8 on the basis of a program stored in a predetermined storage device such as the ROM described above, for example.

The amplitude detected by the amplitude detection unit 7 and the phase difference detected by the phase difference detection unit 5 are input to the calibration calculation unit 8a. Then, values of the parameters A1 to An and B1 to Bn are calculated (described later) by the calibration calculation unit 8a and stored in the memory unit 9 as the parameter information 9a (values of the parameters A1 to An and B1 to Bn are overwritten). Thus, appropriate values of the parameters A1 to An and B1 to Bn are always stored as the parameter information 9a, and when the user causes the distance measuring device 1 to execute the distance measurement, a correct distance measurement result can be obtained by [Expression 1].

Note that it is conceivable that the calculation by the calibration calculation unit 8a and the overwriting processing on the memory unit 9 are automatically performed in response to, for example, establishment of a predetermined trigger condition when the user turns on the power of the distance measuring device 1.

The present embodiment is characterized in that a plurality of frequencies f (light emission frequencies) is used in calibration. Specifically, T (T is a natural number of 2 or more) frequencies f are used. Hereinafter, the frequency is denoted by f(t). Here, t is 1 to T. For example, f(1)=10 MHz, f(2)=11 MHz, f(3)=12 MHz, and so on. Note that it is assumed that the frequency f(1) of t=1 is the lowest frequency. Regarding T, for example, T=15.

Here, the circular error and the signal propagation delay depend on t. That is, for each t, the circular error and the signal propagation delay are stored as the correction parameters in the memory unit 9 as the parameter information 9a.

Hereinafter, parameters of the circular error at t are denoted by A1(t) to An(t) and B1(t) to Bn(t).

Furthermore, it is assumed that parameters a(t), b(t), and c(t) of signal propagation delay at each frequency f(t) are measured at the time of shipment from the factory. It is assumed that the parameters a(t), b(t), and c(t) of the signal propagation delay measured in advance are also stored in the memory unit 9 as the parameter information 9a. Note that, in Chapter 4 of Non Patent Document 1, a(t) is described as b0, b(t) is described as b1, and c(t) is described as b2.

The processing of FIG. 3 will be described.

First, in step S101, the calibration calculation unit 8a sets h=1. Then, the processing proceeds to step S102.

In step S102, the calibration calculation unit 8a determines whether h is equal to or less than H. If it is equal to or less than H, the processing proceeds to step S103.

Here, H is the number of measurements (predetermined value) for calibration, and for example, H=40. Furthermore, since the measurement is performed at intervals of a predetermined time k, the calibration requires a time of H×k. Only H different target objects (different distances) will be measured.

In step S103, the calibration calculation unit 8a sets t=1. Then, the processing proceeds to step S104.

In step S104, the calibration calculation unit 8a determines whether t is equal to or less than T. If it is equal to or less than T, the processing proceeds to step S105.

In step S105, the calibration calculation unit 8a performs execution control of light emission/light reception by the frequency f(t). That is, the light emitting unit 2 emits the irradiation light Ls at the frequency f(t), and the sensor unit 3 receives the reflected light Lr.

In step S106 subsequent to step S105, the calibration calculation unit 8a causes the phase difference detection unit 5 to detect a phase difference at each pixel position (u, v) and acquires the phase difference as a phase difference p(h, t, u, v). Then, the processing proceeds to step S107.

In step S107, the calibration calculation unit 8a increments t by 1 in order to obtain data for the next frequency f, and returns to step S104.

In a case where it is determined in step S104 that t is not equal to or less than T, that is, in a case where the phase difference p(h, t, u, v) is acquired in step S106 for each light emission frequency of t=1 to T, the calibration calculation unit 8a proceeds to step S108.

In step S108, the calibration calculation unit 8a performs discard processing of the phase difference p(h, t, u, v) based on the magnitude of the amplitude. Specifically, in a case where any one of the “(T of t=1 to T) amplitudes of the light reception signal at the frequency f(t)” at each pixel position (u, v) is less than the predetermined value, the phase difference p(h, t, u, v) for (h, u, v) (sum T of t=1 to T) thereof is discarded. In other words, in step S108, if the amplitudes at all the frequencies f(t)(t=1 to T) at all the pixel positions (u, v) are equal to or more than a predetermined value, no processing is performed.

The small amplitude means that the reflected light from the target object Ob is small, so that the reliability of the measurement data is reduced. Accordingly, such data is discarded.

Here, in a case where the data discard is performed in step S108, all the measurements of the h-th phase difference p(h, t, u, v) become invalid, and thus, in the present example, h=h−1 in a case where the data discard is performed.

In step S109 following step S108, the calibration calculation unit 8a performs processing of waiting for a predetermined time k in order to perform the next measurement ((h+1)-th measurement), thereafter increments h by 1 in step S110, and returns to the previous step S102.

Thus, the measurement of the phase difference p(h, t, u, v) for each of the T light emission frequencies is performed H times.

In a case where it is determined in step S102 that h is not equal to or less than H, the calibration calculation unit 8a proceeds to step S111 and performs 2π indefiniteness elimination processing. Specifically, in step S111, processing of eliminating the 2π indefiniteness of the phase difference p(h, t, u, v) is performed for each h, each t, and each (u, v). The phase difference from which the 2π indefiniteness is eliminated is denoted by θ(h, t, u, v).

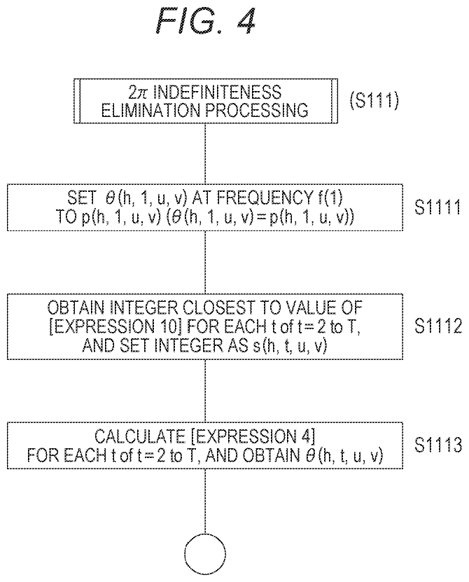

Note that details of the 2π indefiniteness elimination processing in step S111 will be described later (see FIG. 4).

In step S112 subsequent to step S111, the calibration calculation unit 8a obtains parameters (parameters A1(t) to An(t) and B1(t) to Bn(t)) of the circular error satisfying [Expression 3] described later. The obtained parameters are stored in the memory unit 9 as the parameter information 9a (values of the parameters A1(t) to An(t) and B1(t) to Bn(t) are overwritten).

The calibration calculation unit 8a terminates the series of processes illustrated in FIG. 3 in response to execution of the processing of step S112.

Here, the calculation processing in step S112 will be supplemented.

The following [Expression 2] represents the relationship between the phase difference θ(h, t, u, v) at the pixel position (u, v) in the h-th measurement and the distance L(h, u, v) to the distance measurement target point (distance measurement point) projected at the pixel position (u, v). Here, t is 1 to T.

$$\begin{matrix}[ Expression 2 ] & \\ {L}_{( h , u , v )} = \frac{c}{4 π {f}_{( t )}} \{ {ϕ}_{( h , t , u , v )} + {\sum }_{n = 1}^{N} {A}_{n ( t )} sin ( n {ϕ}_{( h , t , u , v )} + {B}_{n ( t )} ) \} & [ Expression 2 ]\end{matrix}$$

$$where {ϕ}_{( h , t , u , v )} = {θ}_{( h , t , u , v )} + {a}_{( t )} + {b}_{( t )} u + {c}_{( t )} v$$

It is clear from the analogy of [Expression 1] that [Expression 2] holds. It should be noted in [Expression 2] that the distance L(h, u, v) does not depend on t. Naturally, the distance to the target object Ob does not change even if the measurement is performed while changing the frequency f(t), and thus L(h, u, v) does not depend on t. Note that, since the distance to the target object Ob is unknown, L(h, u, v) is an unknown number.

Furthermore, in [Expression 2], the parameters a(t), b(t), and c(t) of the signal propagation delay at each frequency f(t) can be known by reading those stored as the parameter information 9a. Here, t is 1 to T.

In this example, although the parameters of An and Bn are obtained by calibration, it is assumed that values at the time of factory shipment are continuously used for the parameters a(t), b(t), and c(t) of the signal propagation delay.

Therefore, it is only required to obtain the parameters A1(t) to An(t) and B1(t) to Bn(t) satisfying [Expression 2] using data other than (h, u, v) discarded in step S108. Actually, it is obtained by a least squares method. Specifically, it is only required to obtain A1(t) to An(t) and B1(t) to Bn(t) and L (h, u, v) that minimize [Expression 3].

$$\begin{matrix}[ Expression 3 ] & \\ {\sum }_{h = 1}^{H} {\sum }_{t = 1}^{T} {\sum }_{( u , v )}^{} {( {L}_{( h , u , v )} - \frac{c}{4 π {f}_{( t )}} \{ {ϕ}_{( h , t , u , v )} + {\sum }_{n = 1}^{N} {A}_{n ( t )} sin ( n {ϕ}_{( h , t , u , v )} + \dot{{B}_{n ( t )}} ) \} )}^{2} & [ Expression 3 ]\end{matrix}$$

$$where {ϕ}_{( h , t , u , v )} = {θ}_{( h , t , u , v )} + {a}_{( t )} + {b}_{( t )} u + {c}_{( t )} v$$

Here, the effectiveness of the present method will be supplemented.

[Expression 3] holds for each (h, t, u, v) of h=1 to H, t=1 to T, u=1 to U, and v=1 to V. That is, when the processing proceeds to step S112, H×T×U×V equations are obtained. On the other hand, an unknown parameter is a sum (2×N×T)+(H×U×V) of An(t) (n=1 to N and t=1 to T), Bn(t) (n=1 to N and t=1 to T), and L(h, u, v) (h=1 to H, u=1 to U, and v=1 to V). Therefore, if (2×N×T)+(H×U×V) H×T×U×V, the number of equations is larger than the number of unknowns, and the solution can be performed. Actually, by increasing T, that is, by increasing the number of light emission frequencies of the light emitting unit 2, (2×N×T)+(H×U×V) S H×T×U×V can be satisfied. Alternatively, it is possible to satisfy (2× N×T)+(H×U×V)<H×T×U×V by increasing H, that is, measuring the phase difference for various scenes.

That is, the present embodiment utilizes the fact that (2×N×T)+(H×U×V) S H×T×U×V can be satisfied when T is 2 or more. In other words, a feature of the present embodiment is to “measure phase difference using a plurality of light emission frequencies (at least two different light emission frequencies) for the same object”. Accordingly, even if the distance to the object is unknown, unknown parameters An(t) (n=1 to N and t=1 to T), Bn(t) (n=1 to N and t=1 to T), L(h, u, v) (h=1 to H, u=1 to U, and v=1 to V) can be obtained. That is, a circular Error (An(t) (n=1 to N and t=1 to T), Bn(t) (n=1 to N and t=1 to T)) can be obtained.

Note that, in FIG. 3, the processing of setting h=h−1 when the data is discarded is executed in step S108, but if T and H are determined such that H×T−U−V is sufficiently larger than (2×N×T)+(H×U×V) (the number of pieces of measurement data has a margin), the processing of setting h=h−1 can be omitted.

FIG. 4 is a flowchart illustrating the 2π indefiniteness elimination processing of step S111.

As described with reference to FIG. 2, the phase difference p(h, t, u, v) measured for each pixel of the sensor unit 3 has 2n indefiniteness. That is, for each (h, t, u, v), it is unclear which of the following [Expression 4] the true phase difference θ (h, t, u, v) is.

[Expression 4]

θ_{(h,t,u,v)}=p_{(h,t,u,v)}+2s_{(h,t,u,v)}π [Expression 4]

Note that, in [Expression 4], s(h, t, u, v) is an integer of 0 or more.

Here, as the distance to the target object Ob increases, the amount of light reflected by the target object Ob from the light emitting unit 2 and reaching the sensor unit 3 also decreases. That is, the light reception signal has a small amplitude. Furthermore, since the data having the small amplitude is discarded in step S108, the distance to the target object Ob corresponding to the (h, t, u, v) to be targeted in step S11 is not so long. Accordingly, it can be said that the distance to the target object Ob corresponding to the (h, t, u, v) targeted in step S111 satisfies [Expression 5].

$$\begin{matrix}[ Expression 5 ] & \\ {L}_{( h , u , v )} \leq \frac{c}{4 π {f}_{( 1 )}} ( {a}_{( 1 )} + {b}_{( 1 )} u + {c}_{( 1 )} v + 2 π ) & [ Expression 5 ]\end{matrix}$$

Note that f(1) in [Expression 5] is the lowest frequency among the frequencies f(t) of t=1 to T as described above.

Therefore, for t=1, the true phase difference θ(h, t, u, v) is s(h, t, u, v)=0 in [Expression 4], and can be determined by the following [Expression 6] from the phase difference p(h, t, u, v) measured for each pixel of the sensor unit 3.

[Expression 6]

θ_{(h,l,u,v)}=p_{(h,l,u,v)} [Expression 6]

Furthermore, the irradiation light Ls emitted from the light emitting unit 2 is not a perfect sine wave but has a waveform substantially similar to the sine wave, and thus the amount of circular error is small. From this point, the following [Expression 7] is established.

$$\begin{matrix}[ Expression 7 ] & \\ {L}_{( h , u , v )} \approx \frac{c}{4 π {f}_{( t )}} ( {p}_{( h , t , u , v )} + {a}_{( t )} + {b}_{( t )} u + {c}_{( t )} v + 2 {s}_{( h , t , u , v )} π ) & [ Expression 7 ]\end{matrix}$$

In [Expression 7], when t=1, s(h, t, u, v)=0 is determined. Therefore, the following [Expression 8] is established.

$$\begin{matrix}[ Expression 8 ] & \\ \frac{c}{4 π {f}_{( t )}} ( {p}_{( h , t , u , v )} + {a}_{( t )} + {b}_{( t )} u + {c}_{( t )} v + 2 {s}_{( h , t , u , v )} π ) \approx \frac{c}{4 π {f}_{( 1 )}} ( {p}_{( h , 1 , u , v )} + {a}_{( 1 )} + {b}_{( 1 )} u + {c}_{( 1 )} v ) & [ Expression 8 ]\end{matrix}$$

By modifying [Expression 8], the following [Expression 9] is obtained.

$$\begin{matrix}[ Expression 9 ] & \\ 2 {s}_{( h , t , u , v )} \approx \{ \frac{{f}_{( t )}}{{f}_{( 1 )}} ( {p}_{( h , 1 , u , v )} + {a}_{( 1 )} + {b}_{( 1 )} u + {c}_{( 1 )} v ) - ( {p}_{( h , t , u , v )} + {a}_{( t )} + {b}_{( t )} u + {c}_{( t )} v ) \} / π & [ Expression 9 ]\end{matrix}$$

For t=2 to T, s(h, t, u, v) can be determined from [Expression 9]. That is, it is only required to set the integer closest to the following [Expression 10] to s(h, t, u, v).

$$\begin{matrix}[ Expression 10 ] & \\ \{ \frac{{f}_{( t )}}{{f}_{( 1 )}} ( {p}_{( h , 1 , u , v )} + {a}_{( 1 )} + {b}_{( 1 )} u + {c}_{( 1 )} v ) - ( {p}_{( h , t , u , v )} + {a}_{( t )} + {b}_{( t )} u + {c}_{( t )} v ) \} / 2 π & [ Expression 10 ]\end{matrix}$$

When s(h, t, u, v) is determined for t=2 to T, the true phase difference e(h, t, u, v) can also be determined from the above [Expression 4].

The processing of FIG. 4 will be described on the basis of the above.

First, in step S1111, the calibration calculation unit 8a sets θ(h, l, u, v) at the frequency f(1) to p(h, l, u, v). That is, θ(h, l, u, v)=p(h, l, u, v). As described above, the frequency f(1) at t=1 is lower than the other frequencies (f(2) to f(T)).

In step S1112 following step S1111, the calibration calculation unit 8a obtains an integer closest to the value of [Expression 10] for each t of t=2 to T, and sets the obtained integer as s(h, t, u, v).

Moreover, in step S1113 following step S1112, the calibration calculation unit Sa calculates [Expression 4] for each t of t=2 to T to obtain the true phase difference e(h, t, u, v).

In response to the execution of the processing of step S1113, the calibration calculation unit 8a ends the 2π indefiniteness elimination processing of step S111.

Here, the indefiniteness elimination processing described above can be rephrased as follows.

That is, among the phase differences detected from the light reception signal when light emission is performed at the lowest light emission frequency (frequency f(1)) that is the lowest light emission frequency among the light emission frequencies for the calibration calculation processing, the phase difference detected from the light reception signal having an amplitude equal to or more than a predetermined value is determined as the phase difference corresponding to the lowest light emission frequency, and the processing of eliminating the 2π indefiniteness with respect to the phase difference corresponding to another one of the light emission frequencies other than the lowest light emission frequency is performed on the basis of the determined phase difference corresponding to the lowest light emission frequency.

### 2. Second Embodiment

Next, a second embodiment will be described.

In the second embodiment, calibration for obtaining the correction parameter in the background is performed.

Note that, in the second embodiment, since the hardware configuration of the distance measuring device 1 is similar to that in the case of the first embodiment, illustration thereof is omitted. Furthermore, in the following description, the same reference numerals are given to portions similar to those already described, and description thereof is omitted.

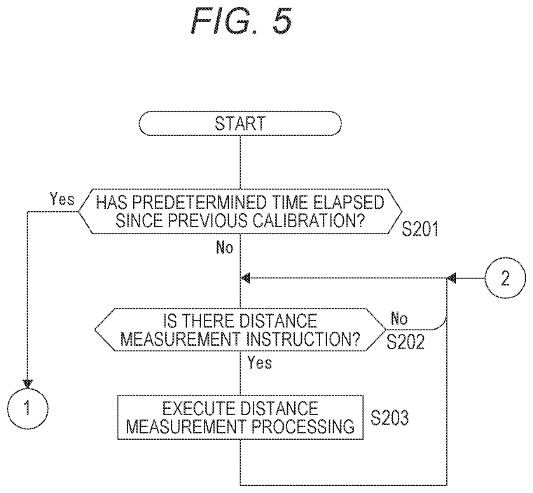

FIG. 5 is a flowchart of processing executed by the control unit 8 in the second embodiment.

The processing illustrated in FIG. 5 is started in response to satisfaction of a predetermined trigger condition determined in advance such as turning on the power of the distance measuring device 1 or activating an application for distance measurement, for example.

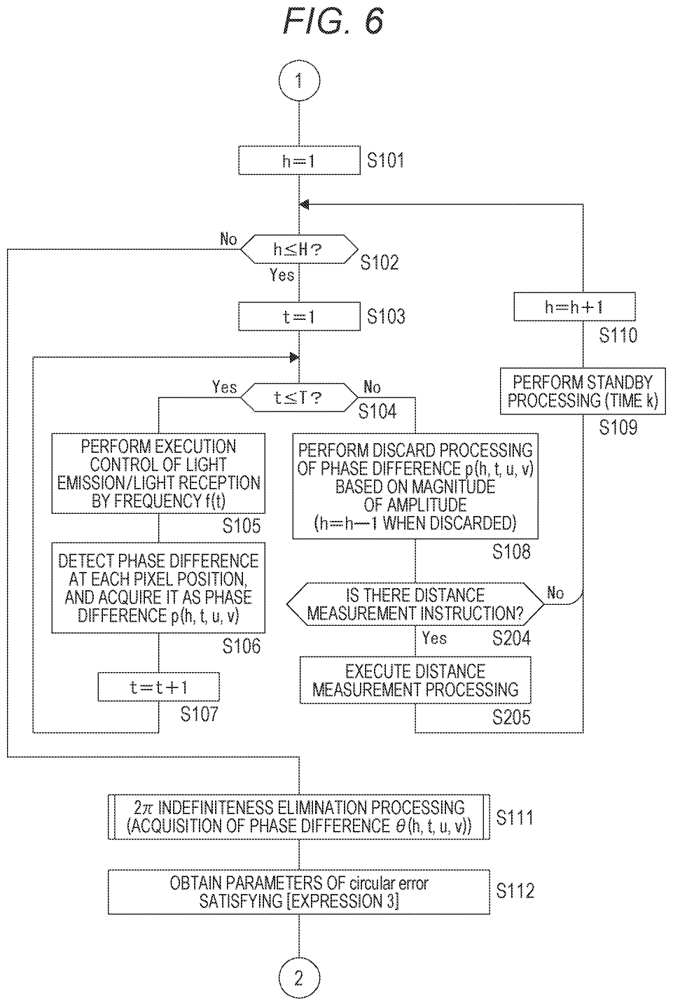

In this case, in step S201, the control unit 8 determines whether a predetermined time (for example, one year or the like) has elapsed since the previous calibration. When the predetermined time has elapsed, there is a possibility that a secular change has occurred. Thus, in a case where it is determined in step S201 that the predetermined time has elapsed, the control unit 8 executes processing as the calibration calculation unit 8a illustrated in FIG. 6.

On the other hand, when the predetermined time has not elapsed, it is considered that the secular change has not occurred, and the processing illustrated in FIG. 6 is not executed.

In a case where it is determined that the predetermined time has not elapsed, the control unit 8 proceeds to step S202, and performs processing of waiting for a distance measurement instruction from the user via the operation unit 11, for example, as the distance measurement instruction. In a case where there is a distance measurement instruction, the control unit 8 proceeds to step S203 and executes distance measurement processing. That is, a light emitting operation of the irradiation light Ls by the light emitting unit 2 and the light receiving operation of the reflected light Lr by the sensor unit 3 are executed, the phase difference detection unit 5 is caused to execute the detection of the phase difference, and the calculation unit 6 is caused to execute the calculation of the distance.

In response to execution of the distance measurement processing in step S203, the control unit 8 returns to step S202.

In the second embodiment, by the processing illustrated in FIG. 6, calibration is performed between distance measurement processes performed in accordance with the distance measurement instruction from the user.

The processing illustrated in FIG. 6 is different from that in FIG. 3 in that processing in steps S204 and S205 is inserted between steps S108 and S109.

In this case, the control unit 8 (calibration calculation unit 8a) proceeds to step S204 and determines whether the distance measurement instruction has been given in response to that the discard processing in step S108 is executed. In a case where there is no distance measurement instruction, the control unit 8 proceeds to step S109. That is, if there is no distance measurement instruction, the processing proceeds to the same processing as that in FIG. 3 (flow proceeding to step S109 after the processing of step S108).

In a case where the distance measurement instruction has been given, the control unit 8 proceeds to step S205, executes distance measurement processing (as processing, similar to that in above step S203), and proceeds to step S109.

The flow of the processing in FIG. 6 is basically the same as that in FIG. 3, but is different in that, in a case where the distance measurement instruction is given between step S108 and step S109 in FIG. 3, the calibration processing is temporarily interrupted, and the distance measurement is performed (step S205).

In this case, the control unit 8 advances the processing to step S202 in FIG. 5 in response to the execution of the processing of step S112.

As described above, in the second embodiment, the calibration for obtaining the correction parameter can be performed in the background while the user uses the distance measuring device 1.

### 3. Third Embodiment

In a third embodiment, calibration is performed on the condition that distance measurement points have a specific positional relationship with each other.

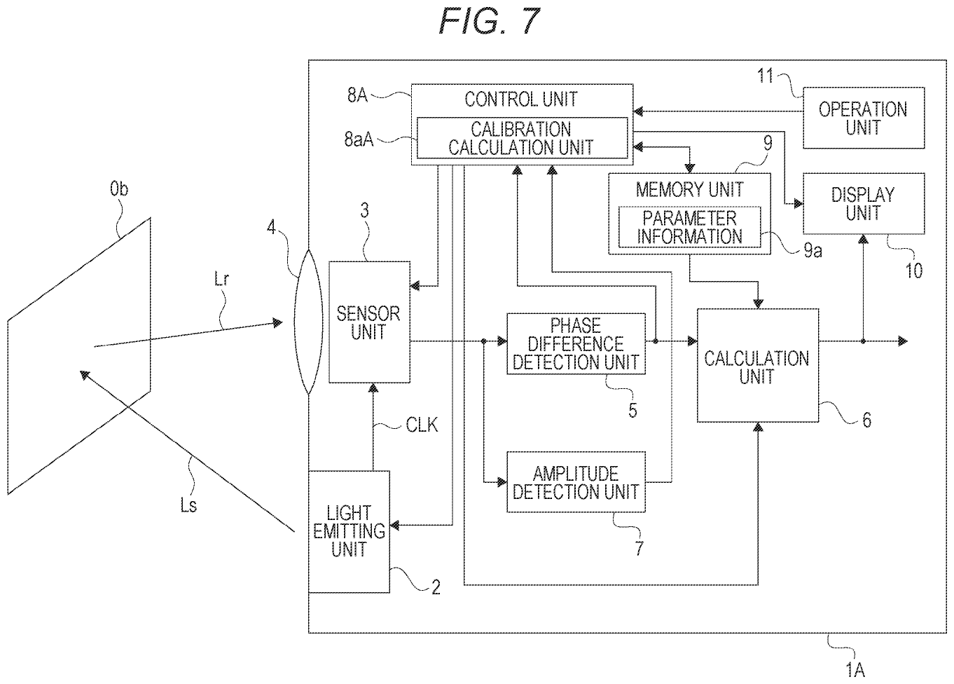

FIG. 7 is a block diagram for describing an internal configuration example of a distance measuring device 1A as the third embodiment.

A difference from the distance measuring device 1 is that a control unit 8A is provided instead of the control unit 8. The hardware configuration of the control unit 8A is similar to that of the control unit 8, but the control unit 8A is different in that calculation processing is performed by a method different from the case of the first embodiment as the calibration calculation processing. Here, a function of performing the calibration calculation processing by the method as the third embodiment described below is referred to as a calibration calculation unit 8aA.

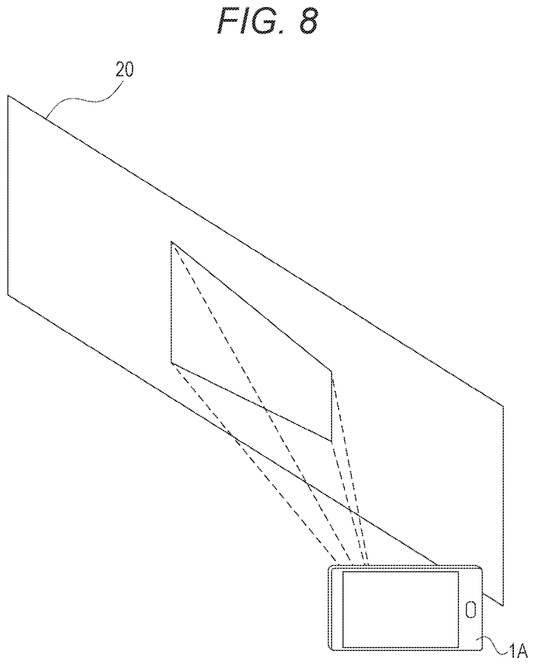

In the third embodiment, as illustrated in FIG. 8, calibration is performed by obliquely image capturing (measuring a phase difference) a flat plate 20 with an unknown distance. The distance to the flat plate 20 may be unknown, and thus the precise device is not required.

FIG. 8 schematically illustrates a state in which a part of the flat plate 20 is projected on the distance measuring device 1A side.

Here, also in the third embodiment, the number of pixels of the sensor unit 3 is denoted by U×V, and each pixel position is denoted by (u, v) (u=1 to U and v=1 to V).

In this example, an area of (u, v) (u=U0 to U0+U1, v=V0 to V0+V1) is referred to as a planar imaging area Ar. For example, U0=U/4, V0=V/3, U1=U/2, and V1=V/3.

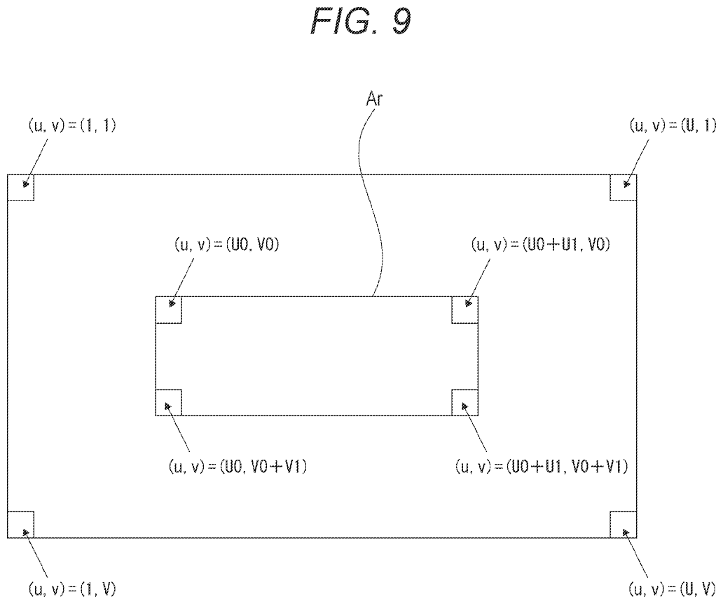

These positional relationships are illustrated in FIG. 9.

At the time of calibration, the user performs image capturing such that the same plane of the flat plate 20 appears in the planar imaging area Ar of the sensor unit 3.

In the present example, the control unit 8A causes the display unit 10 to display a guide image such that a guide (that is, a guide of imaging composition) for causing the user to perform image capturing is performed so that the same plane of the flat plate 20 appears in the planar imaging area Ar in this manner.

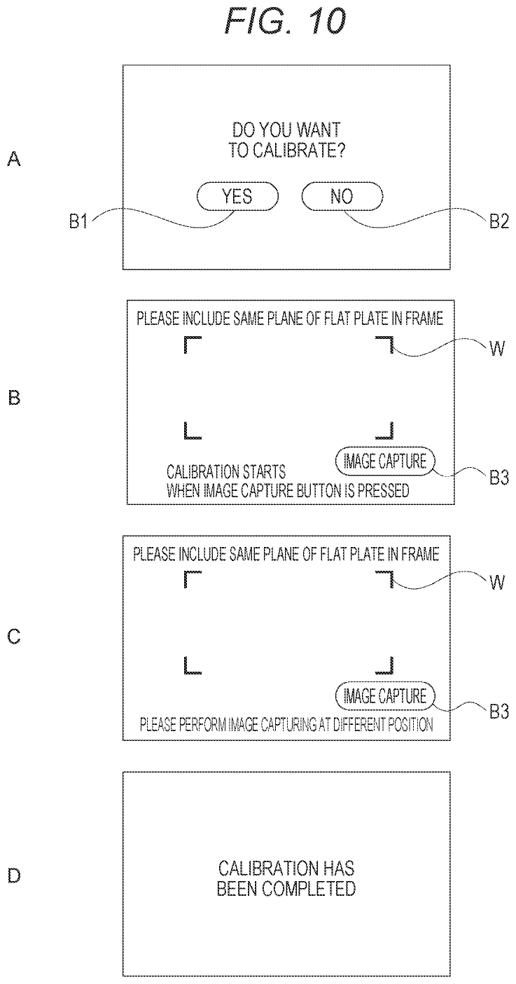

FIG. 10 is a diagram for describing an example of guide display at a time of calibration including display of such a guide image.

First, a calibration inquiry screen illustrated in FIG. 10A is displayed. On this calibration inquiry screen, a “YES” button B1 and a “NO” button B2 are displayed together with an inquiry message such as “do you want to calibrate?” as to whether or not to execute calibration.

In a case of giving an instruction on the execution of the calibration, the user operates the “YES” button B1.

In a case where the “YES” button B1 is operated, a frame screen illustrated in FIG. 10B is displayed. On the frame screen, a frame W indicating the size of the planar imaging area Ar described above is displayed, a message prompting to include the flat plate 20 in the frame W, such as “please include the same plane of the flat plate in the frame”, and an “image capture” button B3 for giving an instruction on the start of measurement of the phase difference for calibration are displayed.

In this example, as in the case of the first embodiment, H times of measurement are performed while changing the distance in the calibration. In the frame screen illustrated in FIG. 10B, in a case where the “image capture” button B3 is operated and the first measurement is executed, the frame screen illustrated in FIG. 10C is displayed on the display unit 10.

The difference from the frame screen in FIG. 10B is that a message prompting performing image capturing at a different distance, such as “please perform image capturing at a different position”, is displayed.

In a case where H times of measurement are executed and the calibration calculation processing is completed, a calibration completion screen illustrated in FIG. 10D is displayed. As illustrated in the drawing, on the calibration completion screen, a message providing notification that the calibration calculation processing has been completed, such as “calibration has been completed”, is displayed.

Here, on the frame screen in FIG. 10B or 10C, an image (for example, a distance image) obtained by the light receiving operation of the sensor unit 3 is displayed in real time. Thus, the user can easily adjust the composition to an appropriate composition while viewing the screen of the display unit 10.

Note that the object used at the time of calibration is not limited to the flat plate 20. For example, it may be a wall of a user's house, an outer wall of a building, or the like.

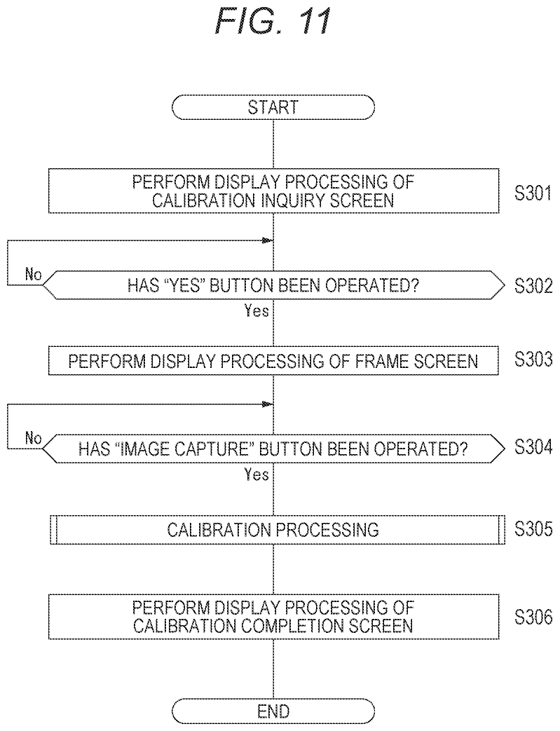

FIG. 11 is a flowchart illustrating a flow of processing when performing calibration as the third embodiment.

The processing illustrated in FIG. 11 is started in response to satisfaction of a predetermined trigger condition determined in advance such as turning on the power of the distance measuring device 1A or activating the application for distance measurement, for example.

First, in step S301, the control unit 8A performs processing of causing the display unit 10 to display a calibration inquiry screen as illustrated in FIG. 10A as display processing of the calibration inquiry screen.

In step S302 following step S301, the control unit 8A stands by until the above-described “YES” button B1 is operated, and in a case where the “YES” button B1 is operated, the processing proceeds to step S303 to perform the display processing of the frame screen illustrated in FIG. 10B.

Note that, in a case where the “NO” button B2 is operated on the calibration inquiry screen, for example, it is only required to perform processing of transitioning to a predetermined screen such as a distance measurement screen.

In step S304 following step S303, the control unit 8A stands by until the “image capture” button B3 on the frame screen is operated, and in a case where the “image capture” button B3 is operated, the control unit 8A executes the calibration processing of step S305 and proceeds to step S306.

Note that the calibration processing in step S305 is performed on the condition that the distance measurement points are in a specific positional relationship with each other, and details will be described later.

In step S306, the control unit 8A executes the display processing of the calibration completion screen illustrated in FIG. 10D and terminates the series of processing illustrated in FIG. 11.

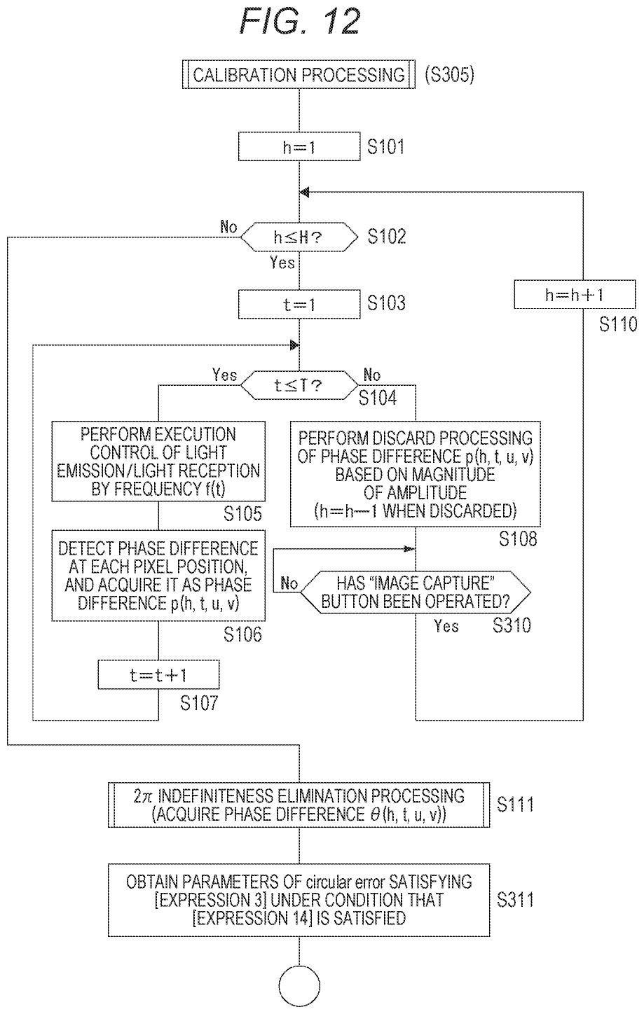

FIG. 12 is a flowchart of the calibration processing in step S305.

As illustrated, the calibration processing illustrated in FIG. 12 is different from the calibration processing described above with reference to FIG. 3 in that the standby processing (time k) in step S109 is omitted, the processing (image capture button standby processing) in step S310 is executed in accordance with the execution of the processing in step S108, and the processing in step S311 is executed instead of the processing in step S112.

First, regarding the determination processing in step S102, also in this case, H is set to, for example, H=40 or the like. In the third embodiment, the phase difference is measured only H times in different compositions (that is, the user moves the distance measuring device 1A). That is, in the third embodiment, it is assumed that planes at different distances are measured each time the value of h is incremented.

Furthermore, in the present example, as the calibration calculation processing, a method of using a plurality of light emission frequencies as in the first embodiment is employed while using a condition that the distance measurement points are in a specific positional relationship with each other. Thus, also in the third embodiment, the phase difference is measured for a plurality of t where the plurality of t=1 to T.

In the processing of FIG. 12, in response to execution of the discard processing of step S108, the control unit 8A proceeds to step S310 and waits until the “image capture” button B3 is operated.

Note that, although illustration is omitted, in the third embodiment, the control unit 8A performs processing of updating the frame screen to the frame screen illustrated in FIG. 10C after the “image capture” button B3 on the frame screen illustrated in FIG. 10B is operated and before the discard processing in step S108 is executed for the first time. Therefore, the “image capture” button B3 for waiting for the operation in step S310 is the “image capture” button B3 on the frame screen illustrated in FIG. 10C.

In a case where it is determined in step S310 that the “image capture” button B3 has been operated, the control unit 8A advances the processing to step S110.

Furthermore, in the third embodiment, the target for which the phase difference is detected in the processing of step S106 is in the range of u=U0 to U0+U1 and v=V0 to V0+V1 among the respective pixel positions (u, v) of the sensor unit 3. Thus, the phase difference detected for each distance measurement point on the same plane can be used for the calculation processing of the correction parameter.

The processing of step S311 is basically processing of obtaining the parameters (parameters A1(t) to An(t) and B1(t) to Bn(t)) of the circular error that satisfy [Expression 3] similarly to step S112 illustrated in FIG. 3 above.

The control unit 8A terminates the calibration processing in step S305 in response to execution of the processing in step S311.

Here, regarding the processing in step S311, in the third embodiment, there is a certain condition when [Expression 3] is solved.

Hereinafter, the calculation in step S311 will be described in detail.

First, the direction in which the pixel position (u, v) captures an image is denoted by (dₓ(u, v), d_{y}(u, v), d_{z}(u, v)). For example, assuming that the lens 4 is not distorted and the focal length is F_{L}, the direction in which the pixel position (u, v) is image-captured is expressed by the following [Expression 11].

$$\begin{matrix}[ Expression 11 ] & \\ [ \begin{matrix}{d}_{x ( u , v )} \\ {d}_{y ( u , v )} \\ {d}_{z ( u , v )}\end{matrix} ] ∝ [ \begin{matrix}u - ( U / 2 ) \\ v - ( V / 2 ) \\ {F}_{L}\end{matrix} ] & [ Expression 11 ]\end{matrix}$$

The direction (dₓ(u, v), d_{y}(u, v), d_{z}(u, v)) in which the pixel position (u, v) captures an image is determined by the characteristics of the lens 4. Then, for example, since the characteristics are determined when the lens 4 is designed, the characteristics can be known.

Note that it is assumed that the three-dimensional vector (dₓ(u, v), d_{y}(u, v), d_{z}(u, v)) is normalized. That is, it is assumed that the following [Expression 12] is satisfied.

[Expression 12]

\sqrt{d_{x(u,v)}²+d_{y(u,v)}²+d_{z(u,v)}²}=1 [Expression 12]

Assuming that the distance to the point on the flat plate 20 projected at the pixel position (u, v) when the flat plate 20 is image-captured for the h-th time is denoted by L(h, u, v), the position in the three-dimensional space of the point on the flat plate 20 projected at the pixel position (u, v) is expressed by [Expression 13].

$$\begin{matrix}[ Expression 13 ] & \\ {L}_{( h , u , v )} [ \begin{matrix}{d}_{x ( u , v )} \\ {d}_{y ( u , v )} \\ {d}_{z ( u , v )}\end{matrix} ] & [ Expression 13 ]\end{matrix}$$

The position of the flat plate 20 in the three-dimensional space at the h-th time is considered. In this example, the position of the object in the three-dimensional space projected at all the pixel positions (u, v) (u=U0 to U0+U1, v=V0 to V0+V1) is on one plane. That is, on a plane passing through the positions of the object in the three-dimensional space projected at three pixel positions of positions (U0, V0), (U0+1, V0), and (U0, V0+1), there is also a position of the object in the three-dimensional space projected at the pixel position of another position (u, v). Therefore, the following [Expression 14] is satisfied.

$$\begin{matrix}[ Expression 14 ] & \\ {{{L}_{( h , u , v )} [ \begin{matrix}{d}_{x ( u , v )} \\ {d}_{y ( u , v )} \\ {d}_{z ( u , v )}\end{matrix} ]}^{T} [ \begin{matrix}{d}_{x ( {U}_{0} , {V}_{0} )} & {d}_{y ( {U}_{0} , {V}_{0} )} & {d}_{z ( {U}_{0} , {V}_{0} )} \\ {d}_{x ( {U}_{0} + 1 , {V}_{0} )} & {d}_{y ( {U}_{0} + 1 , {V}_{0} )} & {d}_{z ( {U}_{0} + 1 , {V}_{0} )} \\ {d}_{x ( {U}_{0} , {V}_{0} + 1 )} & {d}_{y ( {U}_{0} , {V}_{0} + 1 )} & {d}_{z ( {U}_{0} , {V}_{0} + 1 )}\end{matrix} ]}^{- 1} [ \begin{matrix}\frac{1}{{L}_{( h , {U}_{0} , {V}_{0} )}} \\ \frac{1}{{L}_{( h , {U}_{0} + 1 , {V}_{0} )}} \\ \frac{1}{{L}_{( h , {U}_{0} , {V}_{0} + 1 )}}\end{matrix} ] = 1 & [ Expression 14 ]\end{matrix}$$

Note that the subscript T in [Expression 14] means a transposed matrix.

To summarize the above, the direction (dₓ(u, v), d_{y}(u, v), d_{z}(u, v)) in which the pixel position (u, v) captures the image is known. Then, since the same plane is imaged in the planar imaging area Ar in the h-th image capturing (measurement of the phase difference), [Expression 14] is satisfied for the pixels of u=U0 to U0+U1 and v=V0 to V0+V1. Note that L(h, u, v) in [Expression 14] is a distance to the flat plate 20 projected at a pixel position (u, v) when the flat plate 20 is imaged for the h-th time.

Now, [Expression 2] represents the relationship between the phase difference G(h, t, u, v) at the pixel position (u, v) in the h-th measurement and the distance L(h, u, v) to the distance measurement point projected at the pixel position (u, v). Here, t is 1 to T.

As described above, it is clear from the analogy of [Expression 1] that [Expression 2] holds.

Note that, since the distance to the target object Ob is unknown, L(h, u, v) is an unknown number. However, L(h, u, v) satisfies [Expression 14] as described above.

Therefore, under the condition that [Expression 14] is satisfied, it is only required to obtain the parameters A1(t) to An(t) and B1(t) to Bn(t) satisfying [Expression 2]. Actually, also in this case, it is determined by the least squares method, and therefore, under the condition that [Expression 14] is satisfied, it is only required to obtain A1(t) to An(t) and B1(t) to Bn(t) and L(h, u, v) that minimize [Expression 3] described above.

That is, the calculation in step S311 is to obtain A1(t) to An(t) and B1(t) to Bn(t) and L(h, u, v) that minimize [Expression 3] under the condition that [Expression 14] is satisfied for each (u, v) (where u=U0 to U0+U1, v=V0 to V0+V1). Then, the obtained parameters A1(t) to An(t) and B1(t) to Bn(t) are used as parameters of the circular error.

Here, it will be supplemented that the calibration method of the third embodiment (method using a condition that the distance measurement points are in a specific positional relationship) is effective. In step S311, “a solution that satisfies the equations expressed by [Expression 2] and [Expression 14] is obtained”. [Expression 2] holds for each (h, t, u, v) of h=1 to H, t=1 to T, u=U0 to U0+U1, and v=V0 to V0+V1. That is, when the processing proceeds to step S311, H×T× U1× V1 equations are obtained.

Moreover, [Expression 14] holds for each (h, u, v) of h=1 to H, u=U0 to U0+U1, and v=V0 to V0+V1. However, the sets of (u, v)=(U0, V0), (u, v)=(U0+1, V0), and (u, v)=(U0, V0+1) are excluded. That is, H× (U1−V1−3) equations are obtained.

Therefore, at the time of proceeding to step S311, (H×T×U1×V1)+(H×(U1×V1−3)) equations are obtained.

On the other hand, an unknown parameter is a sum (2×N×T)+(H×U1×V1) of An(t) (n=1 to N and t=1 to T), Bn(t) (n=1 to N and t=1 to T), and L(h, u, v) (h=1 to H, u=U0 to U0+U1, v=V0 to V0+V1). Therefore, if (2×N×T)+(H×U1×V1)≤(H×T×U1×V1)+(H×(U1×V1−3)), the number of equations is larger than the number of unknowns, and it can be solved. Actually, if at least one of U1, V1, or H is sufficiently large, (2×N×T)+(H×U1×V1)≤(H×T×U1×V1)+(H×(U1×V1−3)) can be satisfied.

Note that, even if T=1, the above inequality can be satisfied. That is, T needs to be a natural number of 2 or more in the first embodiment, but T is only required to be a natural number of 1 or more in the third embodiment.

Note that, regarding the processing of FIG. 12, the 2π indefiniteness elimination processing of step S111 is similar to that described in FIG. 4, and thus redundant description is avoided.

### 4. Modification Examples

Note that the embodiment is not limited to the specific examples described above, and various modification examples can be employed.

For example, although the example in which the distance measuring device according to the present technology is applied to a portable information processing device such as a smartphone has been described above, the distance measuring device according to the present technology is not limited to be applied to a portable information processing device, and can be widely and suitably applied to various electronic devices.

Furthermore, in the processing of FIG. 3 described in the first embodiment and the processing of FIG. 12 described in the third embodiment, when (h+1)-th measurement from the h-th measurement is performed, it is desirable that the positional relationship with the target object Ob is changed. Accordingly, for example, in the processing of FIG. 3, processing of determining whether the distance measuring device 1 is moving on the basis of a detection signal of an acceleration sensor or an angular velocity sensor built in the distance measuring device 1 may be provided between steps S109 and S110. In this case, if the distance measuring device 1 is moving, the processing proceeds to step S110, and if not, the determination processing is performed again. Thus, the (h+1)-th measurement can be reliably performed on an object at a distance different from that of the h-th measurement.

Furthermore, regarding the processing of FIG. 12, for example, it is conceivable to similarly provide processing of determining whether the distance measuring device 1A is moving between steps S310 and S110, proceed to step S110 if the distance measuring device 1 is moving, and perform the determination processing again if not.

### 5. Summary of Embodiment

As described above, a first distance measuring device (same 1) as an embodiment includes a light emitting unit (same 2) that emits light, a light receiving sensor (sensor unit 3) that receives the light emitted from the light emitting unit and reflected by a target object, and a calibration calculation unit (same 8a) that performs, as calibration calculation processing for obtaining a correction parameter for distance information calculated by an indirect ToF method on the basis of a light reception signal of the light receiving sensor, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

By using a plurality of light emission frequencies, the correction parameter can be obtained even if the distance to the target object is indefinite.

Therefore, it is possible to alleviate a precondition for establishing calibration, and it is possible to execute the calibration even in an actual use environment of the device.

Since the calibration can be executed even in the actual use environment, it is possible to absorb a change in the correction parameter due to a secular change, and it is possible to suppress a decrease in distance measurement accuracy over time.

Furthermore, in the first distance measuring device as the embodiment, the calibration calculation unit performs calculation processing based on a phase difference between light emission and light reception detected on the basis of the light reception signal, and obtains the correction parameter.

Thus, it is possible to obtain an appropriate correction parameter corresponding to a case of performing distance measurement by the indirect ToF method as the phase difference method.

Moreover, in the first distance measuring device as the embodiment, the calibration calculation unit performs indefiniteness elimination processing of eliminating indefiniteness in units of 2π for the phase difference (see step S111).

Thus, the calculation processing of the correction parameter can be performed using the phase difference from which the indefiniteness in units of 2π has been eliminated.

Therefore, accuracy of the correction parameter can be improved, and the distance measurement accuracy can be improved.

Furthermore, in the first distance measuring device as the embodiment, the calibration calculation unit determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

With respect to the phase difference corresponding to the lowest light emission frequency, the indefiniteness in units of 2π can be eliminated by selecting the phase difference detected from the light reception signal having the amplitude equal to or more than the predetermined value as described above, and with respect to the phase difference corresponding to another one of the light emission frequencies other than the lowest light emission frequency, a true phase difference can be specified on the basis of the phase difference corresponding to the lowest light emission frequency from which the indefiniteness is eliminated in this manner (that is, the indefiniteness in units of 2π can be eliminated).

Therefore, the calculation processing of the correction parameter can be performed on the basis of the phase difference from which the indefiniteness in units of 2π has been eliminated, and by improving the accuracy of the correction parameter, the distance measurement accuracy can be improved.

Furthermore, in the first distance measuring device as the embodiment, the calibration calculation unit executes the calibration calculation processing on the basis of an elapsed time from previous execution (see step S201).

Thus, even in a case where the correction parameter deviates from the true value over time, it is possible to recalibrate the correction parameter.

Therefore, it is possible to prevent the distance measurement accuracy from deteriorating over time as the correction parameter changes over time.

Moreover, in the first distance measuring device as the embodiment, in a case where a distance measurement instruction is given during execution of the calibration calculation processing, the calibration calculation unit interrupts the calibration calculation processing and performs processing for distance measurement (see FIG. 6).

Thus, even in a case where the calibration calculation processing is performed in the background, the calibration calculation processing is interrupted in a case where a distance measurement instruction is given, and a distance measurement operation is performed according to the instruction.

Therefore, usability can be improved.

Furthermore, a first calibration method as an embodiment is a calibration method in a distance measuring device that includes a light emitting unit that emits light, and a light receiving sensor that receives the light emitted from the light emitting unit and reflected by a target object, and performs distance measurement by an indirect ToF method on the basis of a light reception signal of the light receiving sensor, the calibration method including performing, as calibration calculation processing for obtaining a correction parameter for distance information calculated by the indirect ToF method, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

Also by such a first calibration method, it is possible to obtain a similar operation and effect to those of the first distance measuring device described above.

A second distance measuring device (same 1A) as an embodiment includes a light emitting unit (same 2) that emits light, a light receiving sensor (sensor unit 3) that receives the light emitted from the light emitting unit and reflected by a target object by a plurality of pixels, and a calibration calculation unit (same 8aA) that performs, as calibration calculation processing for obtaining a correction parameter for distance information calculated by an indirect ToF method on the basis of a light reception signal of the light receiving sensor, calculation processing using a condition that respective distance measurement points projected onto a plurality of the pixels are in a specific positional relationship with each other.

By using the condition that the distance measurement points are in a specific positional relationship with each other as described above, the correction parameter can be obtained even if the distance to the target object is indefinite.

Therefore, it is possible to alleviate a precondition for establishing calibration, and it is possible to execute the calibration even in an actual use environment of the device.

Since the calibration can be executed even in the actual use environment, it is possible to absorb a change in the correction parameter due to a secular change, and it is possible to suppress a decrease in distance measurement accuracy over time.

Furthermore, in the second distance measuring device as an embodiment, the calibration calculation unit performs calculation processing using a condition that the distance measurement points are on an object having a known shape as the calibration calculation processing.

If the distance measurement points are on an object having a known shape, the positional relationship between the distance measurement points can be defined as a mathematical expression by the known shape.

Therefore, it is possible to alleviate a precondition for establishing calibration, and it is possible to execute the calibration even in an actual use environment of the device.

Furthermore, since the calibration can be executed even in the actual use environment, it is possible to absorb a change in the correction parameter due to a secular change, and it is possible to suppress a decrease in distance measurement accuracy over time.

Moreover, in the second distance measuring device as the embodiment, the calibration calculation unit performs, as the calibration calculation processing, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency (see FIG. 12).

That is, as the calibration calculation processing, calculation processing using a plurality of light emission frequencies is performed while using the condition that respective distance measurement points are in a specific positional relationship with each other, and thus it is possible to increase the number of equations for an unknown number.

Therefore, the correction parameter can be obtained more robustly, and the distance measurement accuracy can be improved.

Furthermore, in the second distance measuring device as the embodiment, the calibration calculation unit performs calculation processing based on a phase difference between light emission and light reception detected on the basis of the light reception signal, and obtains the correction parameter.

Thus, it is possible to obtain an appropriate correction parameter corresponding to a case of performing distance measurement by the indirect ToF method as the phase difference method.

Furthermore, in the second distance measuring device as the embodiment, the calibration calculation unit performs indefiniteness elimination processing of eliminating the indefiniteness in units of 2π for the phase difference.

Thus, the calculation processing of the correction parameter can be performed using the phase difference from which the indefiniteness in units of 2π has been eliminated.

Therefore, the accuracy of the correction parameter can be improved, and the distance measurement accuracy can be improved.

Moreover, in the second distance measuring device as the embodiment, the calibration calculation unit determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

With respect to the phase difference corresponding to the lowest light emission frequency, the indefiniteness in units of 2π can be eliminated by selecting the phase difference detected from the light reception signal having the amplitude equal to or more than the predetermined value as described above, and with respect to the phase difference corresponding to another one of the light emission frequencies other than the lowest light emission frequency, a true phase difference can be specified on the basis of the phase difference corresponding to the lowest light emission frequency from which the indefiniteness is eliminated in this manner (that is, the indefiniteness in units of 2π can be eliminated).

Therefore, the calculation processing of the correction parameter can be performed on the basis of the phase difference from which the indefiniteness in units of 2π has been eliminated, and by improving the accuracy of the correction parameter, the distance measurement accuracy can be improved.

Furthermore, the second distance measuring device as the embodiment includes a guide display processing unit that performs display processing of a guide image that guides a composition for satisfying a condition that the distance measurement points are in a specific positional relationship with each other (the control unit 8A, see FIGS. 10 and 11).

Thus, it is possible to increase the possibility that the correction parameter is calibrated under the condition that the distance measurement points are in a specific positional relationship with each other.

Therefore, the accuracy of the correction parameter can be improved, and the distance measurement accuracy can be improved.

Furthermore, a second calibration method as an embodiment is a calibration method in a distance measuring device that performs, with a light emitting unit that emits light and a light receiving sensor that receives the light emitted from the light emitting unit and reflected by a target object by a plurality of pixels, distance measurement by an indirect ToF method on the basis of a light reception signal of the light receiving sensor, the calibration method including performing calculation processing using a condition that respective distance measurement points projected onto a plurality of the pixels are in a specific positional relationship with each other as calibration calculation processing for obtaining a correction parameter for distance information calculated by the indirect ToF method.

Also by such a second calibration method, it is possible to obtain a similar operation and effect to those of the second distance measuring device described above.

Note that effects described in the present description are merely examples and are not limited, and other effects may be provided.

### 6. Present Technology

Note that the present technology can employ configurations as follows.

(1)

A distance measuring device, including:
a light emitting unit that emits light;
a light receiving sensor that receives the light emitted from the light emitting unit and reflected by a target object; and
a calibration calculation unit that performs, as calibration calculation processing for obtaining a correction parameter for distance information calculated by an indirect ToF method on the basis of a light reception signal of the light receiving sensor, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

(2)

The distance measuring device according to (1), in which
the calibration calculation unit
performs calculation processing based on a phase difference between light emission and light reception detected on the basis of the light reception signal, and obtains the correction parameter.

(3)

The distance measuring device according to (2), in which
the calibration calculation unit
performs indefiniteness elimination processing of eliminating indefiniteness in units of 2π for the phase difference.

(4)

The distance measuring device according to (3), in which
the calibration calculation unit
determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

(5)

The distance measuring device according to any one of (1) to (4), in which
the calibration calculation unit
executes the calibration calculation processing on the basis of an elapsed time from previous execution.

(6)

The distance measuring device according to any one of (1) to (5), in which
in a case where a distance measurement instruction is given during execution of the calibration calculation processing, the calibration calculation unit interrupts the calibration calculation processing and performs processing for distance measurement.

(7)

A calibration method in a distance measuring device that includes a light emitting unit that emits light, and a light receiving sensor that receives the light emitted from the light emitting unit and reflected by a target object, and performs distance measurement by an indirect ToF method on the basis of a light reception signal of the light receiving sensor, the calibration method including
performing, as calibration calculation processing for obtaining a correction parameter for distance information calculated by the indirect ToF method, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

(8)

A distance measuring device, including:
a light emitting unit that emits light;
a light receiving sensor that receives the light emitted from the light emitting unit and reflected by a target object by a plurality of pixels; and
a calibration calculation unit that performs, as calibration calculation processing for obtaining a correction parameter for distance information calculated by an indirect ToF method on the basis of a light reception signal of the light receiving sensor, calculation processing using a condition that respective distance measurement points projected onto a plurality of the pixels are in a specific positional relationship with each other.

(9)

The distance measuring device according to (8), in which
the calibration calculation unit
performs calculation processing using a condition that the distance measurement points are on an object having a known shape as the calibration calculation processing.

(10)

The distance measuring device according to (8) or (9), in which
the calibration calculation unit
performs, as the calibration calculation processing, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

(11)

The distance measuring device according to any one of (8) to (10), in which
the calibration calculation unit
performs calculation processing based on a phase difference between light emission and light reception detected on the basis of the light reception signal, and obtains the correction parameter.

(12)

The distance measuring device according to (11), in which
the calibration calculation unit
performs indefiniteness elimination processing of eliminating indefiniteness in units of 2π for the phase difference.

(13)

The distance measuring device according to (12), in which
the calibration calculation unit
determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on the basis of the determined phase difference corresponding to the lowest light emission frequency.

(14)

The distance measuring device according to any one of (8) to (13), further including
a guide display processing unit that performs display processing of a guide image that guides a composition for satisfying a condition that the distance measurement points are in a specific positional relationship with each other.

(15)

A calibration method in a distance measuring device that performs, with a light emitting unit that emits light and a light receiving sensor that receives the light emitted from the light emitting unit and reflected by a target object by a plurality of pixels, distance measurement by an indirect ToF method on the basis of a light reception signal of the light receiving sensor, the calibration method including
performing calculation processing using a condition that respective distance measurement points projected onto a plurality of the pixels are in a specific positional relationship with each other as calibration calculation processing for obtaining a correction parameter for distance information calculated by the indirect ToF method.

### REFERENCE SIGNS LIST

1, 1A Distance measuring device
2 Light emitting unit
3 Sensor unit
4 Lens
5 Phase difference detection unit
6 Calculation unit
7 Amplitude detection unit
8, 8A Control unit
8a, 8aA Calibration calculation unit
9 Memory unit
9a Parameter information
10 Display unit
11 Operation unit
Ob Target object
Ls Irradiation light
Lr Reflected light
Flat plate
W Frame
Ar Planar imaging area

1. A distance measuring device, comprising:
a light emitting unit that emits light;
a light receiving sensor that receives the light emitted from the light emitting unit and reflected by a target object; and
a calibration calculation unit that performs, as calibration calculation processing for obtaining a correction parameter for distance information calculated by an indirect ToF method on a basis of a light reception signal of the light receiving sensor, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

2. The distance measuring device according to claim 1, wherein
the calibration calculation unit
performs calculation processing based on a phase difference between light emission and light reception detected on a basis of the light reception signal, and obtains the correction parameter.

3. The distance measuring device according to claim 2, wherein
the calibration calculation unit
performs indefiniteness elimination processing of eliminating indefiniteness in units of 2π for the phase difference.

4. The distance measuring device according to claim 3, wherein
the calibration calculation unit
determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on a basis of the determined phase difference corresponding to the lowest light emission frequency.

5. The distance measuring device according to claim 1, wherein
the calibration calculation unit
executes the calibration calculation processing on a basis of an elapsed time from previous execution.

6. The distance measuring device according to claim 1, wherein
in a case where a distance measurement instruction is given during execution of the calibration calculation processing, the calibration calculation unit interrupts the calibration calculation processing and performs processing for distance measurement.

7. A calibration method in a distance measuring device that includes a light emitting unit that emits light, and a light receiving sensor that receives the light emitted from the light emitting unit and reflected by a target object, and performs distance measurement by an indirect ToF method on a basis of a light reception signal of the light receiving sensor, the calibration method comprising
performing, as calibration calculation processing for obtaining a correction parameter for distance information calculated by the indirect ToF method, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

8. A distance measuring device, comprising:
a light emitting unit that emits light;
a light receiving sensor that receives the light emitted from the light emitting unit and reflected by a target object by a plurality of pixels; and
a calibration calculation unit that performs, as calibration calculation processing for obtaining a correction parameter for distance information calculated by an indirect ToF method on a basis of a light reception signal of the light receiving sensor, calculation processing using a condition that respective distance measurement points projected onto a plurality of the pixels are in a specific positional relationship with each other.

9. The distance measuring device according to claim 8, wherein
the calibration calculation unit
performs calculation processing using a condition that the distance measurement points are on an object having a known shape as the calibration calculation processing.

10. The distance measuring device according to claim 8, wherein
the calibration calculation unit
performs, as the calibration calculation processing, calculation processing using a light reception signal of the light receiving sensor when the light emitting unit performs light emission at a first light emission frequency and a light reception signal of the light receiving sensor when the light emitting unit performs light emission at a second light emission frequency different from the first light emission frequency.

11. The distance measuring device according to claim 8, wherein
the calibration calculation unit
performs calculation processing based on a phase difference between light emission and light reception detected on a basis of the light reception signal, and obtains the correction parameter.

12. The distance measuring device according to claim 11, wherein
the calibration calculation unit
performs indefiniteness elimination processing of eliminating indefiniteness in units of 2π for the phase difference.

13. The distance measuring device according to claim 12, wherein
the calibration calculation unit
determines, among the phase differences detected from the light reception signal when light emission is performed at a lowest light emission frequency that is a lowest light emission frequency among light emission frequencies of the light emitting unit for the calibration calculation processing, the phase difference detected from the light reception signal having an amplitude equal to or more than a predetermined value as a phase difference corresponding to the lowest light emission frequency, and performs processing of eliminating the indefiniteness with respect to the phase difference corresponding to another one of the light emission frequencies other than the lowest light emission frequency on a basis of the determined phase difference corresponding to the lowest light emission frequency.

14. The distance measuring device according to claim 8, further comprising
a guide display processing unit that performs display processing of a guide image that guides a composition for satisfying a condition that the distance measurement points are in a specific positional relationship with each other.

15. A calibration method in a distance measuring device that performs, with a light emitting unit that emits light and a light receiving sensor that receives the light emitted from the light emitting unit and reflected by a target object by a plurality of pixels, distance measurement by an indirect ToF method on a basis of a light reception signal of the light receiving sensor, the calibration method comprising
performing calculation processing using a condition that respective distance measurement points projected onto a plurality of the pixels are in a specific positional relationship with each other as calibration calculation processing for obtaining a correction parameter for distance information calculated by the indirect ToF method.
